(19) United States
(12) Patent Application Publication
(10) Pub. No.: US 2014/0167391 A1
(43) Pub. Date: Jun. 19, 2014

(54) COUPLER LOCKOUT DEVICE

(71) Applicant: MASTER LOCK COMPANY LLC, Oak Creek, WI (US)

(72) Inventors: Joseph Elliott, Mequon, WI (US); Thomas Walczak, Oconomowoc, WI (US)

(73) Assignee: MASTER LOCK COMPANY LLC, Oak Creek, WI (US)

(21) Appl. No.: 13/798,277

(22) Filed: Mar. 13, 2013

Related U.S. Application Data
(60) Provisional application No. 61/736,671, filed on Dec. 13, 2012.

(51) Int. Cl. B60D 1/60

(52) U.S. Cl. CPC B60D 1/60
USPC 280/507

(57) ABSTRACT

A lockout device for a trailer hitch coupler includes a bottom member and a ratchet body. The bottom member includes a body, a coupler blocking member extending from the body in a vertical direction for engagement with a trailer hitch coupler, and an extension extending from the body in the vertical direction. The ratchet body includes a housing defining a vertical bore sized to receive the extension, a locking mechanism disposed within the housing, and a lock interface assembled with the housing. The locking mechanism is configured to lockingly engage a recess in the extension when the extension is received in the bore. The lock interface is configured to move the locking mechanism from a locked condition to an unlocked condition to disengage the extension recess thereby permitting movement of the ratchet body in a direction away from the bottom member.

### CROSS-REFERENCE TO RELATED APPLICATION

This application claims priority to and the benefit of U.S. Provisional Patent Application Ser. No. 61/736,671, entitled “COUPLER LOCKOUT DEVICE” and filed Dec. 13, 2012, the entire disclosure of which is incorporated herein by reference.

### BACKGROUND

Heavy equipment, trailers, vehicles, and other such items are often transported by being attached to a truck or other such vehicle by a trailer hitch and coupler connection. While the size and weight of such items make them less prone to conventional theft, the inclusion of a coupler assembled with or affixed to the item presents the risk of theft by individuals with a truck having a trailer hitch configured to connect with the coupler.

### SUMMARY

According to an exemplary embodiment of the present application, a lockout device for a trailer hitch coupler includes a bottom member and a ratchet body. The bottom member includes a body, a coupler blocking member extending from the body in a vertical direction for engagement with a trailer hitch coupler, and an extension extending from the body in the vertical direction. The ratchet body includes a housing defining a vertical bore sized to receive the extension, a locking mechanism disposed within the housing, and a lock interface assembled with the housing. The locking mechanism is configured to lockingly engage a recess in the extension when the extension is received in the bore. The lock interface is configured to move the locking mechanism from a locked condition to an unlocked condition to disengage the extension recess thereby permitting movement of the ratchet body in a direction away from the bottom member.

According to another exemplary embodiment of the present application, a method of restricting access to a mounting socket of a trailer hitch coupler is described. In the exemplary method, a bottom member is provided, including a body with a coupler blocking member and an extension each extending from the body in a vertical direction. The bottom member is positioned with respect to the trailer hitch coupler such that the coupler blocking member engages the trailer hitch coupler. A ratchet body is provided, including a housing defining a vertical bore and a locking mechanism disposed within the housing. The extension is inserted into the vertical bore, and the ratchet body is positioned to engage an uppermost surface of the trailer hitch coupler. The locking mechanism is operated to lockingly engage a recess in the extension, thereby securing the ratchet body in engagement with the uppermost surface of the trailer hitch coupler to prevent disengagement of the coupler blocking member from the trailer hitch coupler.

According to another exemplary embodiment of the present application, a method of securing a trailer hitch coupler to a ball mount is described. In the exemplary method, a bottom member is provided, including a body and an extension extending from the body in a vertical direction. The bottom member is positioned below the ball mount such that the extension extends in a vertical direction with respect to the ball mount. A ratchet body is provided, including a housing defining a vertical bore and a locking mechanism disposed within the housing. The extension is inserted into the vertical bore, and the ratchet body is positioned to engage an uppermost surface of the trailer hitch coupler. The locking mechanism is operated to lockingly engage a recess in the extension, thereby securing the ratchet body in engagement with the uppermost surface of the trailer hitch coupler to prevent disengagement of the ball mount from the trailer hitch coupler.

### BRIEF DESCRIPTION OF THE DRAWINGS

Features and advantages of the present application will become apparent from the following detailed description made with reference to the drawings, wherein:

FIG. 1 illustrates a schematic cross-sectional view of a coupler lockout device in accordance with an exemplary embodiment;

FIG. 2 illustrates a front perspective view of another coupler lockout device in accordance with another exemplary embodiment;

FIG. 3 illustrates an upper exploded perspective view of the coupler lockout device of FIG. 2;

FIG. 4 illustrates a lower exploded perspective view of the coupler lockout device of FIG. 2;

FIG. 5 illustrates a front cross-sectional view of the coupler lockout device of FIG. 2, shown assembled with a coupler;

FIG. 6 illustrates a front cross-sectional view of a coupler lockout device adapted for locking out a hitch mounted coupler, in accordance with an exemplary embodiment; and

FIG. 7 illustrates a side cross-sectional view of the coupler lockout device of FIG. 6.

### DETAILED DESCRIPTION

This Detailed Description merely describes exemplary embodiments of the claimed invention and is not intended to limit the scope of the claims in any way. Indeed, the invention as claimed is broader than and unlimited by the exemplary embodiments, and the terms used in the claims have their full ordinary meaning

The present application describes exemplary lockout devices configured to block access to a coupler configured to connect to or couple with a corresponding trailer hitch. Examples of conventional coupling connections include couplers for coupling with ball mount trailer hitches, and coupling pins (or king pin couplers) for coupling with “fifth wheel” trailer hitches. A lockout device may be configured to be lockingly secured over, around, and/or into a hitch-engaging portion of the coupler, to prevent coupling engagement of the coupler with a corresponding trailer hitch. When an authorized user desires to connect the coupler to a trailer hitch (for example, to transport the item to which the coupler is affixed), the user unlocks the lockout device, and moves the lockout device to an open or coupler receiving position and/or removes the lockout device from the coupler. Exemplary coupler lockout devices are described in U.S. Pat. No. 6,722,686 to Koy, U.S. Pat. No. 7,121,121 to Wyers, and U.S. Pat. No. 7,469,919 to Kalous et al., the entire disclosures of each of which are incorporated herein by reference.

According to an exemplary aspect of the present application, a coupler lockout device for a trailer hitch includes a bottom member having a coupler blocking portion for engaging a coupling portion of a trailer hitch coupler (e.g., a ball-receiving socket of a trailer hitch coupler) to prevent hitch mounting of the trailer hitch coupler with a truck or other vehicle, and a ratchet body for assembly with a vertical extension of the bottom member and over the trailer hitch coupler to block removal of the bottom member from this coupling portion engaging position. The ratchet body includes a locking mechanism for lockingly securing the ratchet body with the bottom member.

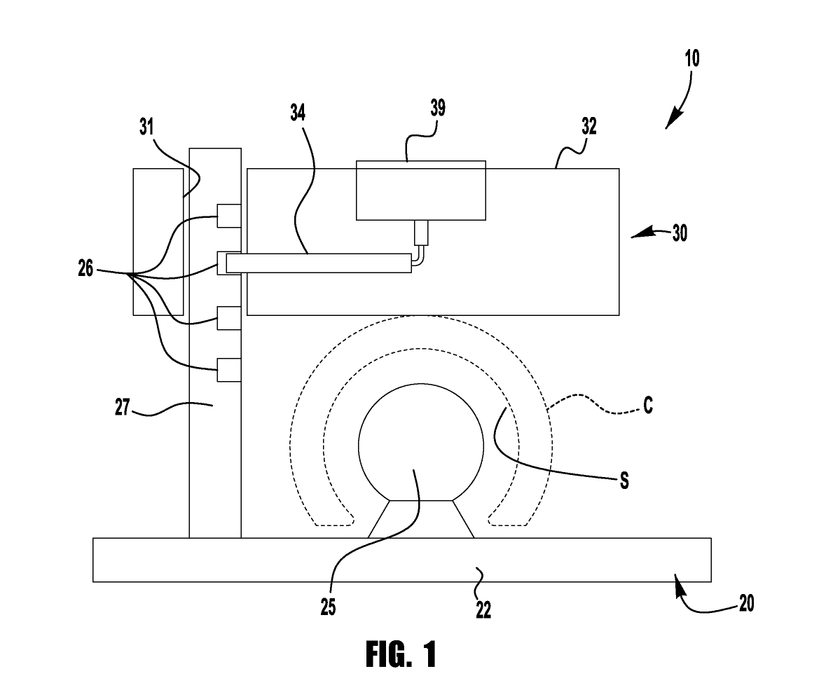

In an exemplary embodiment, as schematically shown in FIG. 1, a coupler lockout device 10 includes a bottom member 20 (e.g., a plate or any other suitable structure) and a ratchet body 30. The bottom member 20 includes a coupler blocking member 25 (e.g., a ball, pin, plug, or plate) extending vertically from or otherwise disposed on a body 22 for interlocking with, blocking, or otherwise obstructing a coupler C. In an exemplary embodiment, the coupler blocking member is sized to extend in a vertical direction into a coupler socket S. In another exemplary embodiment, the coupler blocking member is additionally or alternatively positionable beneath a hitch receiving portion of the coupler (e.g., a socket or other such feature) to at least partially obstruct the hitch receiving portion to prevent engagement of a trailer hitch with the hitch receiving portion. The coupler blocking member 25 may be either integral to or assembled with the body 22. The bottom member 20 further includes at least one extension 27 that extends in a vertical direction from the body 22 and is receivable in a corresponding lock bore or aperture 31 in a housing 32 of the ratchet body 30. The ratchet body 30 includes a locking mechanism 34 disposed within the housing 32 and configured to lockingly engage at least one latch point 26 (e.g., a recess) on the extension 27 when the ratchet body 30 is assembled with the bottom member 20 in a lockout position. In this lockout position, when the coupler lockout device 10 is assembled with the coupler C, the ratchet body 30 engages an uppermost surface of the coupler to prevent movement of the coupler blocking member 25 out of interlocking engagement with the coupler C). The ratchet body 30 includes a lock interface 39 (e.g., a key cylinder or combination dials) configured to move the locking mechanism 34 from a locked position to an unlocked position to permit movement of the ratchet body 30 to a release position (which may, but need not, be separated from the bottom member 20) for removal of the coupler blocking member 25 from interlocking engagement with the coupler C.

Because couplers (and corresponding trailer hitches) vary widely in size, shape, and type of coupling engagement, a coupler lockout device that provides a single lockout position or locking condition may be limited to use with a single type and size of coupler. A coupler lockout device may be configured to provide a plurality of lockout positions or locking conditions to accommodate multiple sizes and types of couplers. In the exemplary embodiment of FIG. 1, the at least one extension 27 includes a plurality of latch points 26 for securing the ratchet body 30 in a plurality or range of lockout positions on the extension 27. In one embodiment, the locking mechanism may be configured such that the ratchet body 30 may be moved inward or downward (e.g., toward locking mechanism engagement with a lower latch point 26) when the locking mechanism is in the locked condition, for example, such that the coupler lockout device may be further tightened onto or around the coupler to be locked out.

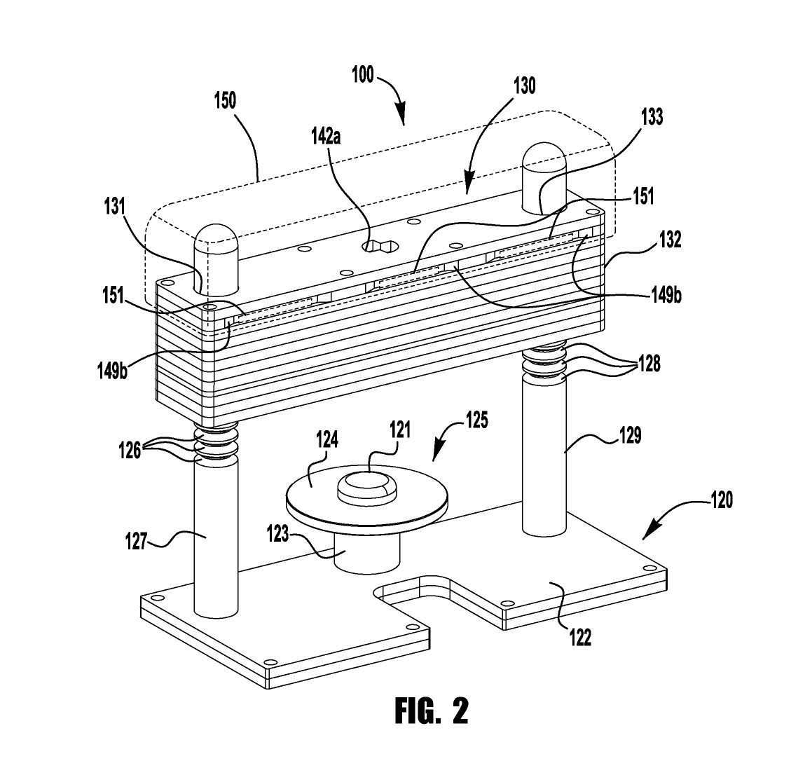

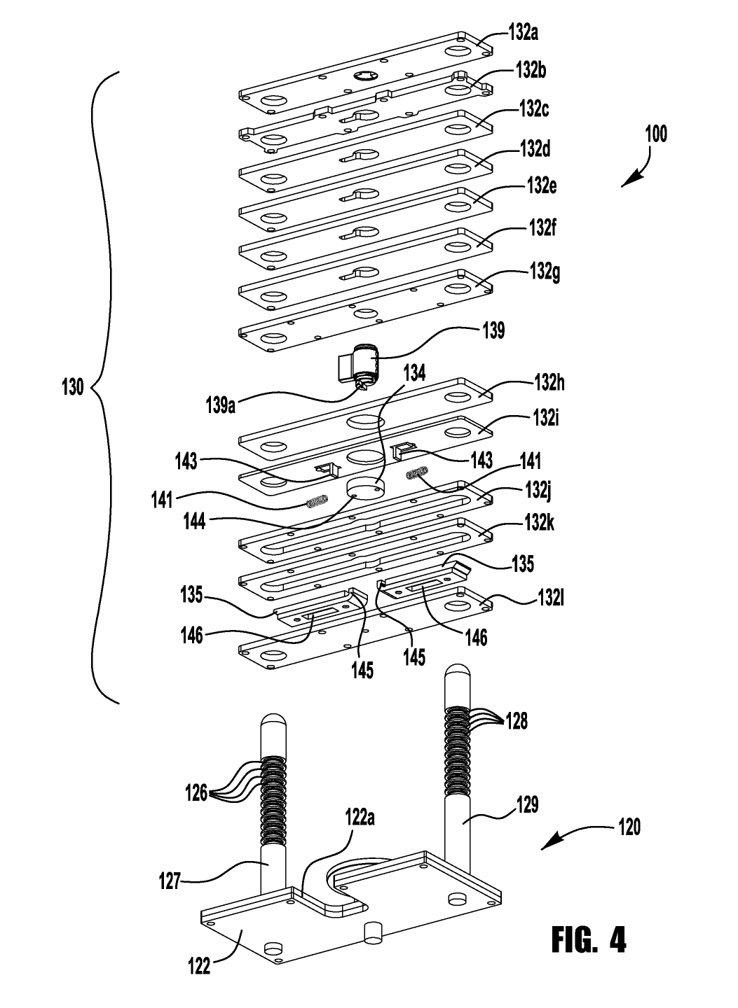

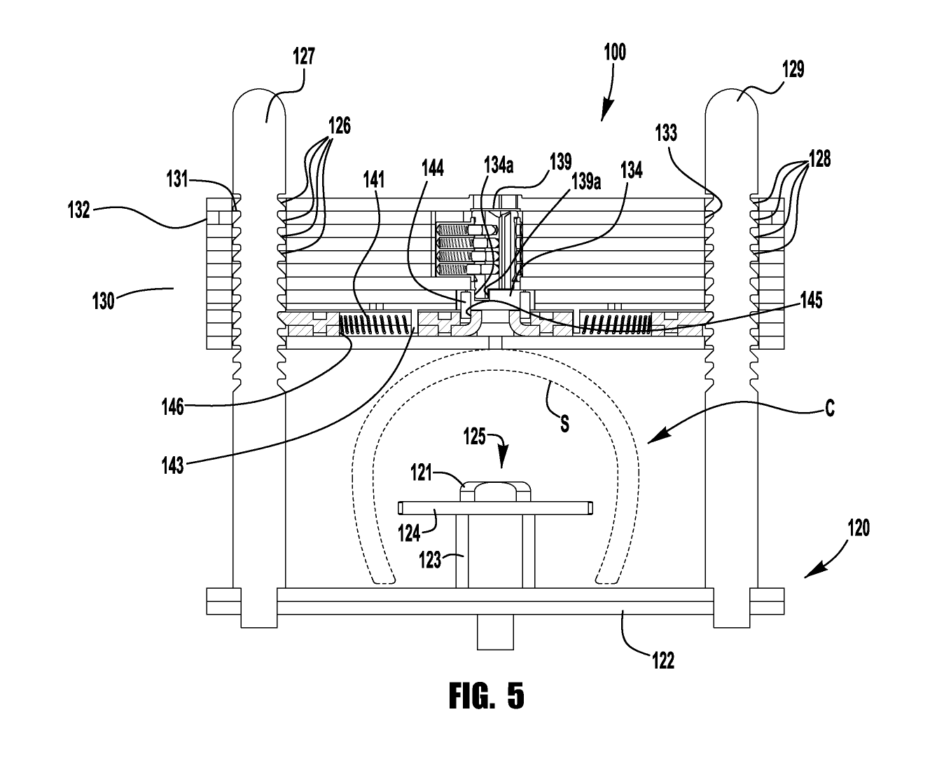

FIGS. 2-5 illustrate various views of exemplary lockout devices 100 for securing with a coupler to prevent coupling engagement of the coupler with a corresponding trailer hitch. The lockout device 100 includes a bottom member 120 (e.g., a plate) and a ratchet body 130. The bottom member 120 includes a post 125 extending from a body 122 for insertion into a socket S of a trailer hitch coupler C (FIG. 5). As shown, the post 125 may include a bolt 121 (or other fastener), a bushing 123, and a washer 124 or other such peripheral projection secured between the bushing and the fastener head and sized to be closely received within the coupler socket S, for example, to reduce movement of the secured lockout device 100 on the coupler C. In an exemplary embodiment, the post 125 is permanently fixed to the body 122. In other embodiments, the post 125 may be removable, for example, for replacement with a different size or shape coupler blocking member (e.g., a different sized socket engaging washer), or for use of the lockout device to secure a mounted coupler to a trailer hitch (as described in greater detail below). The body 122 may be provided with a cutout 122a, for example, for clearance with one or more coupler components (for example, clearance with a nut on a 1⅞ inch size coupler).

The exemplary bottom member 120 includes first and second upstanding bolts 127, 129 (or other such extensions) that extend in a vertical direction from the body 122 and are receivable in corresponding lock bores 131, 133 in a housing 132 of the ratchet body 130. In other embodiments, a different number of ratchet body engaging extensions may be used (e.g., one, or three or more). At least one of the upstanding bolts 127, 129 includes a series of locking recesses 126, 128 (e.g., notches, grooves) or other suitable latch points that are selectively positionable to engage a sliding latch 135 for locking retention of the ratchet body 130 on the bottom member 120. The housing 132 retains a key cylinder lock interface 139 that is operable, upon insertion of an authorized key (not shown) into a keyway 142a in an upper surface of the ratchet body housing 132, to release the ratchet body 130 from the upstanding bolts 127, 129. As schematically shown in phantom in FIG. 2, a sheath or cover 150 may be detachably assembled with the ratchet body housing 132, to protect the keyway 142a and lock apertures 131, 132 from exposure to moisture and other contaminants. The ratchet body housing 132 may include notches 149b (or other suitable features) that receive flexible tabs 151 (or other suitable features) on the cover 150 to releasably retain the cover 150 with the ratchet body housing 132.

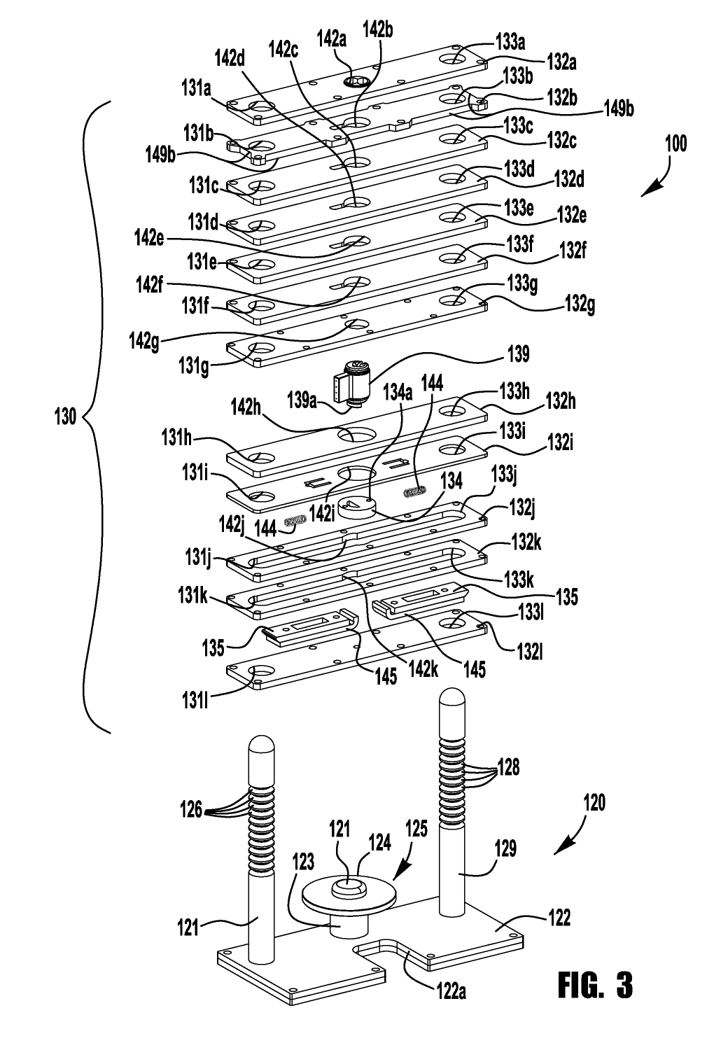

In the exemplary embodiment, user operation of the key cylinder lock interface 139 rotates an actuating cam 134, connected to the key cylinder lock 139, for example, by a tang 139a and recess 134a interlock (see FIG. 3). The actuating cam 134 includes a pin or other such projection 144 received in a slot 145 in the sliding latch 135, such that rotation of the key cylinder lock 139 and cam 134 retracts the latch 135 against an outward biasing spring 141 to disengage the latch 135 from the aligned locking groove. While the exemplary latch 135 is shown as a two-piece laminated plate assembly, any suitable construction may be utilized.

While a ratchet body housing for a coupler lockout device may be formed from any suitable component or components, in an exemplary embodiment, a ratchet body housing is formed from a stack of laminated plates secured together, for example, by rivets, bolts, or other such fasteners. The plates are provided with cutouts sized and positioned to receive lock components, including, for example, a key cylinder, locking levers (or other such locking mechanism components), and openings for receiving lockout plate extensions. In the illustrated embodiment, the ratchet body housing 132 includes a stack of twelve rectangular plates 132a-f, (although any suitable size, shape, and quantity of plates may be utilized) secured together by fasteners (not shown). The plates 132a-l, include openings 131a-l, 133a-l that together define the lock apertures 131, 133. Upper plates 132b-g include central openings 142b-g receiving and retaining the key cylinder lock 139, with a top plate 132a defining a keyway 142a. Central plates 132h-i include central openings 142h-i receiving and retaining the actuating cam 134. Lower plates 132j-k include elongated slots 142j-k, extending to openings 131j-k, 133j-k, in which the sliding latches 135 are received (captured between adjacent central and bottom plates 132i, 132l) and permitted to slide. Central plate 132i further includes flanged tabs 143 receivable in pockets 146 within the sliding latches 135 to guide the latches and to serve as bearing surfaces for the biasing springs 141.

As shown in FIG. 5, when the post 125 of the bottom member 120 is received in the coupler socket S and the ratchet body 130 is secured in a lockout position abutting the top of the coupler C, the body 122 and post 125 block access to the coupler C, thereby preventing insertion of a trailer hitch ball into the coupler socket S (e.g., by an unauthorized individual attempting to haul away the trailer connected with the coupler C). As shown, the recesses 126, 128 and the groove engaging portions of the latches 135 may include tapered or angled lower mating surfaces oriented such that a downward force applied to the ratchet body 120 forces the latch 135 inward against the biasing spring 141 when the key cylinder lock is in an unlocked condition (e.g., by insertion of an authorized key). The recesses 126, 128 and the groove engaging portion of the latch 135 may also include flat or squared upper mating surfaces oriented such that an upward force applied to the ratchet body 120 applies no such inward force to the latch 135.

According to another aspect of the present application, a coupler lockout device may be provided with a detachable or removable coupler blocking member (e.g., a threaded assembly or other detachable arrangement), or may be provided without a coupler blocking member, such that the lockout device may be secured around a hitch mount (e.g., a ball mount) and coupler assembly, for example, to prevent unauthorized detachment of the coupler from the hitch mount.

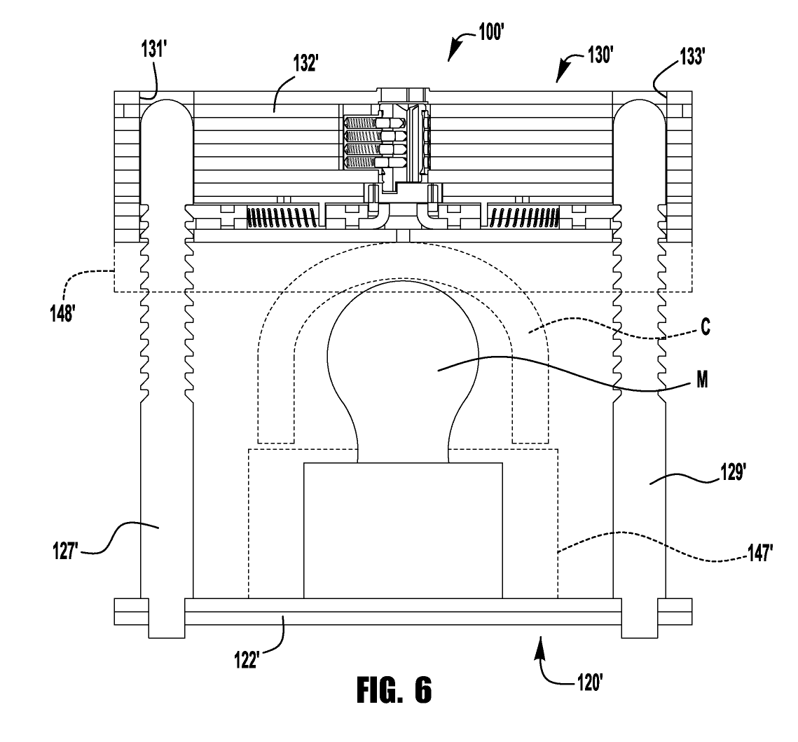

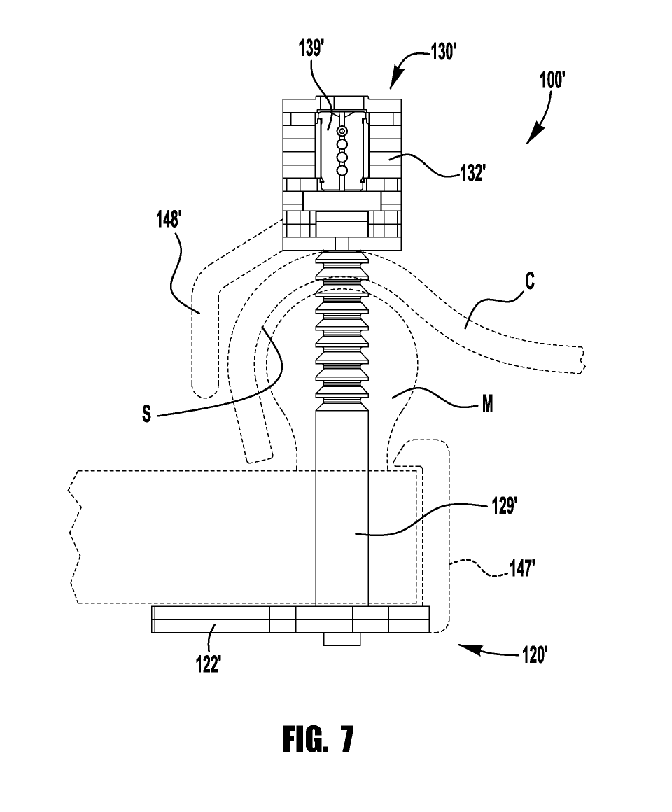

FIGS. 6 and 7 illustrate front and side cross sectional views of an exemplary coupler lockout device 100′ secured around a coupler C mounted to a hitch mount M. As shown, the components of the coupler lockout device 100′ may (but need not) be consistent with the components of the lockout device 100 of FIGS. 2-5, with the post 125 removed or omitted. The lockout device 100′ is configured to provide sufficient space between an upper surface of the body 122′ and a lower surface of the ratchet body housing 132′ to closely receive the assembled hitch mount M and coupler C when the device 100′ is in a lockout position. To prevent axial separation of the locked device 100′ from the mount M and coupler C, the lockout device 100′ may be provided with one or more projections that engage the hitch mount M, thereby retaining the lockout device 100′ in position to secure the coupler C on the hitch mount M. In the illustrated embodiment, the bottom member 120′ is provided with a projection (shown schematically at 147′) that engages an outer edge of the hitch mount M, and the ratchet body 130′ is provided with a projection (shown schematically at 148′) that engages an inner edge of the hitch mount M.

While the lockout device components may be provided in any suitable material, a durable, weather resistant material, such as steel or stainless steel, may be desirable for outdoor applications and for tamper resistance.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, devices and components, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

We claim:

1. A lockout device for a trailer hitch coupler, the device comprising:
a bottom member including a body, a coupler blocking member extending from the body in a vertical direction for engagement with a trailer hitch coupler and an extension extending from the body in the vertical direction; and
a ratchet body including a housing defining a vertical bore sized to receive the extension, a locking mechanism disposed within the housing and configured to lockingly engage a recess in the extension when the extension is received in the bore, and a lock interface assembled with the housing and configured to move the locking mechanism from a locked condition to an unlocked condition to disengage the extension recess thereby permitting movement of the ratchet body in a direction away from the bottom member.

2. The lockout device of claim 1, wherein the coupler blocking member is sized and positioned to be received in a socket of a trailer hitch coupler when the lockout device is assembled with the trailer hitch coupler.

3. The lockout device of claim 1, wherein the extension includes first and second bolts and the ratchet body includes first and second vertical bores sized and positioned to receive the first and second bolts.

4. The lockout device of claim 1, wherein the locking mechanism includes a sliding latch extending into the vertical bore in the locked condition for interlocking engagement with the extension recess when the extension is received in the vertical bore, and refracted from the vertical bore in the unlocked condition for disengagement from the extension recess.

5. The lockout device of claim 4, wherein the extension includes a plurality of recesses for interlocking with the sliding latch, thereby providing a plurality of locking positions of the ratchet body with respect to the bottom member.

6. The lockout device of claim 4, wherein the sliding latch is biased toward the locked condition.

7. The lockout device of claim 4, wherein the locking mechanism further comprises an actuating cam including a latch engaging projection, wherein the locking mechanism is rotatable to retract the sliding latch from the locked condition to the unlocked condition in response to operation of the lock interface.

8. The lockout device of claim 1, further comprising a cover detachably assembled with the ratchet body housing to protect the lock interface and lock bore from exposure to contaminants.

9. The lockout device of claim 1, wherein the ratchet body housing comprises a plurality of laminated plates including cutouts defining the vertical lock bore and a cavity for retaining the locking mechanism.

10. The lockout device of claim 1, wherein the coupler blocking member is detachably assembled to the bottom member body, and removable to permit assembly of the lockout device to a mounted trailer hitch coupler and ball mount assembly.

11. A method of restricting access to a mounting socket of a trailer hitch coupler; the method comprising:
providing a bottom member including a body, with a coupler blocking member and an extension each extending from the body in a vertical direction;
positioning the bottom member with respect to the trailer hitch coupler such that the coupler blocking member engages the trailer hitch coupler;
providing a ratchet body including a housing defining a vertical bore and a locking mechanism disposed within the housing;
inserting the extension into the vertical bore and positioning the ratchet body to engage an uppermost surface of the trailer hitch coupler; and
operating the locking mechanism to lockingly engage a recess in the extension, thereby securing the ratchet body in engagement with the uppermost surface of the trailer hitch coupler to prevent disengagement of the coupler blocking member from the trailer hitch coupler.

12. The method of claim 11, wherein positioning the bottom member with respect to the trailer hitch coupler comprises inserting the coupler blocking member into the socket of the trailer hitch coupler.

13. The method of claim 11, wherein operating the locking mechanism to lockingly engage the recess in the extension comprises rotating an actuating cam to force a sliding latch into interlocking engagement with the extension recess.

14. The method of claim 11, wherein operating the locking mechanism to lockingly engage the recess in the extension comprises operating a key cylinder lock of the ratchet body.

15. The method of claim 11, wherein the extension includes a plurality of recesses, further wherein inserting the extension into the vertical bore and positioning the ratchet body to engage an uppermost surface of the trailer hitch coupler comprises aligning the locking mechanism with a selected one of the plurality of recesses.

16. A method of securing a trailer hitch coupler to a ball mount, the method comprising:
providing a bottom member including a body and an extension extending from the body in a vertical direction;
positioning the bottom member below the ball mount such that the extension extends in a vertical direction with respect to the ball mount;
providing a ratchet body including a housing defining a vertical bore and a locking mechanism disposed within the housing;
inserting the extension into the vertical bore and positioning the ratchet body to engage an uppermost surface of the trailer hitch coupler; and
operating the locking mechanism to lockingly engage a recess in the extension, thereby securing the ratchet body in engagement with the uppermost surface of the trailer hitch coupler to prevent disengagement of the ball mount from the trailer hitch coupler.

17. The method of claim 16, wherein operating the locking mechanism to lockingly engage the recess in the extension comprises rotating an actuating cam to force a sliding latch into interlocking engagement with the extension recess.

18. The method of claim 16, wherein operating the locking mechanism to lockingly engage the recess in the extension comprises operating a key cylinder lock of the ratchet body.

19. The method of claim 16, wherein the extension includes a plurality of recesses, further wherein inserting the extension into the vertical bore and positioning the ratchet body to engage an uppermost surface of the trailer hitch coupler comprises aligning the locking mechanism with a selected one of the plurality of recesses.

20. The method of claim 16, further comprising positioning at least one of the bottom member and the ratchet body to engage an end surface of at least one of the ball mount and the trailer hitch coupler to prevent horizontal disengagement of the bottom member and the ratchet body from the ball mount and the trailer hitch coupler.
